(19) United States
(12) Patent Application Publication
(10) Pub. No.: US 2023/0276557 A1
(43) Pub. Date: Aug. 31, 2023

(54) FLEXIBLE SPLICABLE LIGHT-EMITTING APPARATUS AND SYSTEM AND CONTROL METHOD

(71) Applicant: Shenzhen Lytmi Technology Co., Ltd., Shenzhen (CN)

(72) Inventors: Wentao HU, Shenzhen (CN); Guorong MAO, Shenzhen (CN)

(73) Assignee: Shenzhen Lytmi Technology Co., Ltd., Shenzhen (CN)

(21) Appl. No.: 17/720,317

(22) Filed: Apr. 14, 2022

(30) Foreign Application Priority Data
Feb. 28, 2022 (CN) 202220419474.X

(51) Int. Cl. H05B 47/175; F21V 23/00; F21S 4/24

(52) U.S. Cl. CPC H05B 47/175; F21V 23/003; F21S 4/24

(57) ABSTRACT

A flexible splicable light-emitting apparatus and system and a control method are provided. The light-emitting apparatus includes: at least two flexible light-emitting units and at least two node devices configured to series-connect any two of the flexible light-emitting units in series. Each of the flexible light-emitting units includes: a flexible base and a light-emitting component arranged on the flexible base and being capable of emitting a preset color, brightness, and flicker frequency according to control instructions. Two terminals of each of the flexible light-emitting units are electrically matched with interfaces of the node devices, and two or more of the flexible light-emitting units are electrically connected through the node devices. A combination of the node devices and the flexible light-emitting units forms a preset pattern with intersection points. Any one of the intersection points is formed by series connection of at least two flexible light-emitting units and the node device.

### CROSS REFERENCE TO THE RELATED APPLICATIONS

This application is based upon and claims priority to Chinese Patent Application No. 202220419474.X, filed on Feb. 28, 2022, the entire contents of which are incorporated herein by reference.

### TECHNICAL FIELD

The present disclosure relates to the technical field of light strips, and in particular, to a flexible splicable light-emitting apparatus, system and control method.

### BACKGROUND

At present, many splicable light-emitting products are made of hard materials that cannot be bent and are large and heavy, and there are few light-emitting panels in a single set of accessories, which limits the possibility of pattern splicing. Some light-emitting products on the market use flexible light-emitting components. They are generally equipped with a light strip of about 3 meters, which cannot be cut or extended and branched, and can only simply wrap around the outline of the pattern continuously.

For the products on the market, the light-emitting panels are all made of hard materials. The shape of each set of products is either square, hexagonal, triangular, or elongated. All sets are of a single shape, making it difficult to splice out complex patterns. It mainly realizes the splicing of simple patterns and a change of light and shadow.

### SUMMARY

### I. Technical Problem to be Solved

In view of the above shortcomings and deficiencies in the prior art, the present disclosure provides a flexible splicable light-emitting apparatus and system and a control method, which solve the technical problem that existing light-emitting products have great limitations on pattern editing, making it difficult to form complex patterns required in practice.

### II. Technical Solution

To achieve the above objective, the present disclosure adopts the following technical solution:

In a first aspect, an embodiment of the present disclosure provides a flexible splicable light-emitting apparatus, including: at least two flexible light-emitting units and at least two node devices configured to series-connect any two of the flexible light-emitting units in series.

Each of the flexible light-emitting units includes: a flexible base and a light-emitting component arranged on the flexible base and being capable of emitting a preset color, brightness, and flicker frequency according to control instructions.

Two terminals of each of the flexible light-emitting units are electrically matched with interfaces of the node devices, and two or more of the flexible light-emitting units are electrically connected through the node devices. A combination of the node devices and the flexible light-emitting units forms a preset pattern with intersection points. Any one of the intersection points is an intersection point formed by series connection of at least two flexible light-emitting units and the node device.

In a color display control process of the preset pattern, the node device is configured to send the control instruction to at least one of the connected flexible light-emitting units according to a color display instruction, such that the light-emitting component in any series-connected flexible light-emitting unit in the pattern emits an adjustable color, brightness and/or flicker frequency.

The color display instruction is an instruction sent by a user to all of the node devices in the pattern by an electronic device, or the color display instruction is an instruction generated by a control device in a control system of the light-emitting apparatus according to a preset program.

Optionally, the interface of each of the node devices may include an input terminal and a plurality of output terminals.

The plurality of output terminals of any one of the node devices may be connected to a first terminal of each of the flexible light-emitting units in one-to-one correspondence.

Except for a first node device, the input terminal of any one of other node devices may be connected to a second terminal of a previous flexible light-emitting unit.

Optionally, the light-emitting apparatus may be further provided with: an extender configured to extend a length of a light-emitting display line by connecting two of the flexible light-emitting units.

If the preset pattern has a line with a linear distance greater than a preset length and displays a same color, the flexible light-emitting units may be connected using the extender to form a light-emitting area of the line.

If the preset pattern has a line with a linear distance greater than the preset length and does not display a same color, the flexible light-emitting units may be connected using the node device to form a light-emitting area of the line.

Optionally, two terminals of each of the flexible light-emitting units may be provided with an interface device configured to connect the node device and/or the extender. The interface device may be provided with 4-core signal lines, namely, a power line, a system data line, a lighting data line, and a ground line respectively.

Optionally, the flexible light-emitting unit may be a flexible light strip, and the flexible light strip may include a flexible base, a flexible circuit board, and a light-emitting component.

The flexible base may have a length of 22-28 cm.

The flexible circuit board may be disposed on the flexible base.

The light-emitting component may include a plurality of light beads uniformly distributed in a length direction of the flexible base, and each of the light beads may be connected to the flexible circuit board.

Optionally, the light-emitting apparatus may be allowed to be provided with a maximum of 18 flexible light-emitting units.

In a second aspect, the embodiment of the present disclosure provides a flexible splicable light-emitting system, including: a controller and the flexible splicable light-emitting apparatus as described above that are arranged in pairs.

In the controller and the light-emitting apparatus arranged in a same pair,

the controller is connected to one of the node devices of the light-emitting apparatus, and is communicated with other node devices through the connected node device.

The controller obtains a serial number and port connection status information of the connected node device, and assigns and writes a corresponding control address to the connected node device according to the serial number and the port connection status information of the connected node device.

The controller obtains a serial number and port connection status information of an adjacent node device of the connected node device through the connected node device, and assigns and writes a corresponding control address to the adjacent node device according to the serial number and the port connection status information of the adjacent node device.

The controller expands step by step to acquire serial numbers and port connection status information of all of the node devices in the light-emitting system, and assigns and writes a corresponding control address to each of the node devices.

The controller controls lighting of the light beads on the flexible light-emitting units connected to each of the node devices, performs a current detection operation on all of the light beads on each of the flexible light-emitting units, and determines an effective length of each of the flexible light-emitting units according to a number of light beads that obtain a current.

The controller obtains a topology satisfying the preset pattern according to the control addresses of all of the node devices and the effective lengths of the flexible light-emitting units connected to all ports of each of the node devices.

The controller controls a light-emitting effect of each of the flexible light-emitting units through the node devices to form a light-emitting area based on the topology.

The effective length of each of the flexible light-emitting units is a light-emitting length of each of the flexible light-emitting units capable of being lit.

Optionally, the controller may acquire a sound amplitude and/or a sound frequency within a preset range; and

the controller may control each of the flexible light-emitting units in the light-emitting apparatus to display corresponding light-emitting brightness according to the sound amplitude, and may control each of the flexible light-emitting units in the light-emitting apparatus to display a corresponding light-emitting color according to the sound frequency.

Optionally, the light-emitting system may be further provided with a remote terminal.

The controller may also exchange data with the remote terminal through wireless fidelity (WIFI) and/or Bluetooth, and control the light-emitting effect of each of the flexible light-emitting units according to a control instruction fed back by the remote terminal.

The remote terminal may include: a non-portable terminal and a portable terminal. The non-portable terminal may include: one or more of distributed network devices/systems, server/server groups, and desktop computers. The portable terminal may include: one or more of laptops, smartphones, and tablets.

Optionally, the light-emitting system may further include: a cascade device. Every two pairs of controllers and light-emitting apparatuses that are arranged in pairs may be communicated through the cascade device.

One of the controllers in the light-emitting system may be set as a host according to preset configuration information.

The host may be configured to obtain all node device data of any one of the light-emitting apparatuses in the light-emitting system through the cascade device, and control a color, brightness, and flicker frequency of each of the flexible light-emitting units connected to any one of the node devices in the light-emitting apparatus.

In a third aspect, the embodiment of the present disclosure provides a control method for a flexible splicable light-emitting apparatus, applied to the flexible splicable light-emitting apparatus as described above, and including:

obtaining a serial number and port connection status information of a node device, and assigning and writing a corresponding control address to the node device according to the serial number and the port connection status information of the node device;

obtaining a serial number and port connection status information of an adjacent node device of the node device through the node device, and assigning and writing a corresponding control address to the adjacent node device according to the serial number and the port connection status information of the adjacent node device;

expanding step by step to acquire serial numbers and port connection status information of all of the node devices in a light-emitting system, and assigning and writing a corresponding control address to each of the node devices;

controlling lighting of the light beads on the flexible light-emitting units connected to each of the node devices, performing a current detection operation on all of the light beads on each of the flexible light-emitting units, and determining an effective length of each of the flexible light-emitting units according to a number of light beads that obtain a current;

obtaining a topology satisfying the preset pattern according to the control addresses of all of the node devices and the effective lengths of the flexible light-emitting units connected to all ports of each of the node devices; and

controlling the light-emitting effect of each of the flexible light-emitting units through the node devices to form a light-emitting area based on the topology.

The effective length of each of the flexible light-emitting units is a light-emitting length of each of the flexible light-emitting units capable of being lit.

Optionally, the method may further include:

acquiring a sound amplitude and/or a sound frequency within a preset range; and

controlling each of the flexible light-emitting units in the light-emitting apparatus to display corresponding light-emitting brightness according to the sound amplitude, and controlling each of the flexible light-emitting units in the light-emitting apparatus to display a corresponding light-emitting color according to the sound frequency.

### III. Beneficial Effects

In view of a low degree of freedom of an existing light-emitting apparatus in the prior art, the flexible splicable light-emitting apparatus is provided with multiple flexible light-emitting units and multiple node devices. Each of the node devices is at least connected to one flexible light-emitting unit to control a light-emitting effect of the connected flexible light-emitting unit, and is communicated with other node devices through the connected flexible light-emitting unit. The flexible light-emitting units are spliced and combined by the node devices to form a regular-shaped light-emitting area satisfying a preset pattern, which expands the light-emitting pattern and improve editability of the light-emitting apparatus. The present disclosure controls the light-emitting effect of the flexible light-emitting unit connected to each of the node devices through the node device, thereby controlling each light-emitting control path accurately, and achieving richer pattern light effects.

### BRIEF DESCRIPTION OF THE DRAWINGS

FIG. 1 is a schematic structural diagram of a flexible splicable light-emitting apparatus provided by an embodiment of the present disclosure;

FIG. 2 is a schematic diagram of a pattern display of the flexible splicable light-emitting apparatus provided by the embodiment of the present disclosure;

FIG. 3 is a schematic diagram of another pattern display of the flexible splicable light-emitting apparatus provided by the embodiment of the present disclosure;

FIG. 4 is a schematic diagram of a composition of a node device of the flexible splicable light-emitting apparatus provided by the embodiment of the present disclosure;

FIG. 5 is a schematic circuit diagram of a micro controller unit (MCU) of the node device of the flexible splicable light-emitting apparatus provided by the embodiment of the present disclosure;

FIG. 6 is a schematic diagram of a low dropout regulator (LDO) circuit of the MCU of the node device of the flexible splicable light-emitting apparatus provided by the embodiment of the present disclosure;

FIG. 7 is a schematic diagram of a level conversion circuit of the MCU of the node device of the flexible splicable light-emitting apparatus provided by the embodiment of the present disclosure;

FIG. 8 is a schematic diagram of a composition of an extender of the flexible splicable light-emitting apparatus provided by the embodiment of the present disclosure;

FIG. 9 is a schematic connection diagram of the extender of the flexible splicable light-emitting apparatus provided by the embodiment of the present disclosure;

FIG. 10 is a schematic diagram of a composition of a controller of the flexible splicable light-emitting apparatus provided by the embodiment of the present disclosure;

FIG. 11 is a schematic circuit diagram of a MCU of the controller of the flexible splicable light-emitting apparatus provided by the embodiment of the present disclosure;

FIG. 12 is a schematic diagram of a direct current to direct current (DC-DC) power circuit of the controller of the flexible splicable light-emitting apparatus provided by the embodiment of the present disclosure;

FIG. 13 is a schematic diagram of a WIFI circuit of the controller of the flexible splicable light-emitting apparatus provided by the embodiment of the present disclosure;

FIG. 14 is a schematic diagram of a near field communication (NFC) circuit of the controller of the flexible splicable light-emitting apparatus provided by the embodiment of the present disclosure;

FIG. 15 is a schematic diagram of a FLASH circuit of the controller of the flexible splicable light-emitting apparatus provided by the embodiment of the present disclosure;

FIG. 16 shows a microphone (MIC) acquisition circuit of the controller of the flexible splicable light-emitting apparatus provided by the embodiment of the present disclosure;

FIG. 17 is a schematic connection diagram of a cascade device of the flexible splicable light-emitting apparatus provided by the embodiment of the present disclosure;

FIG. 18 is a schematic diagram of two LDO power circuits of the cascade device of the flexible splicable light-emitting apparatus provided by the embodiment of the present disclosure; and

FIG. 19 is a schematic diagram of an isolated single-wire bidirectional communication circuit of the cascade device of the flexible splicable light-emitting apparatus provided by the embodiment of the present disclosure.

### DETAILED DESCRIPTION OF THE EMBODIMENTS

To facilitate a better understanding of the present disclosure, the present disclosure is described in detail below with reference to the accompanying drawings and specific embodiments.

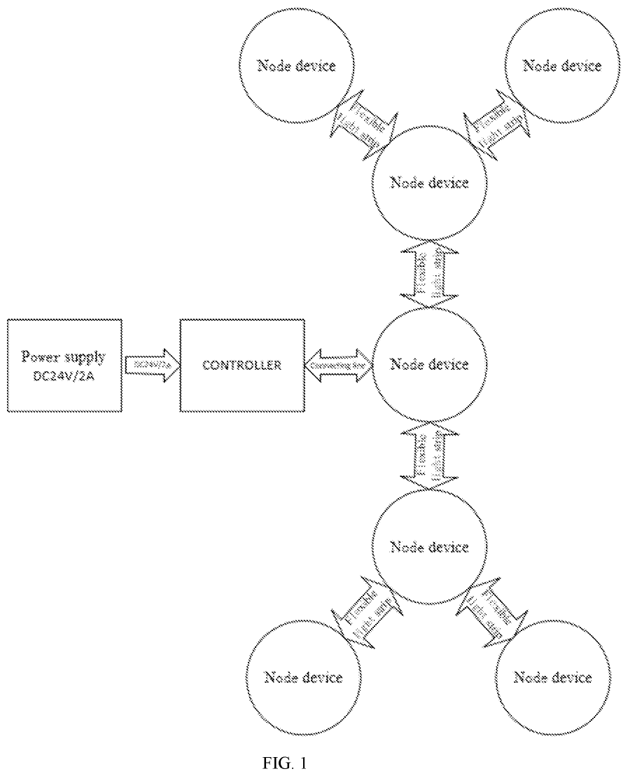

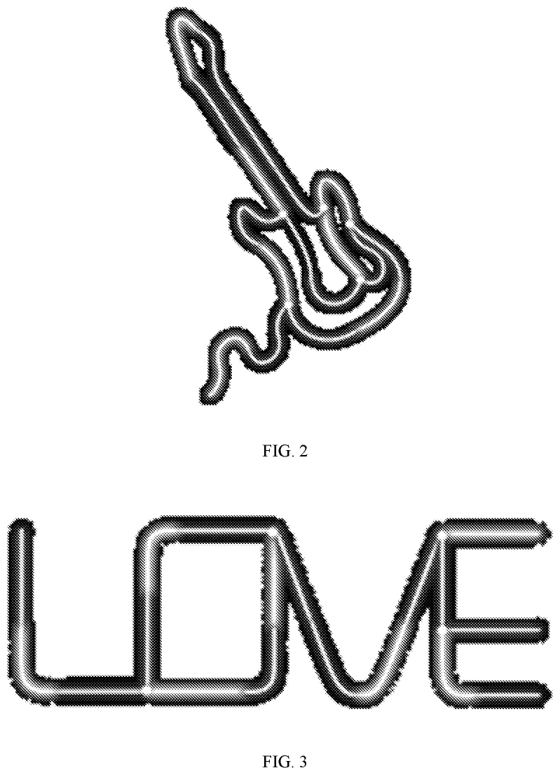

As shown in FIG. 1, an embodiment of the present disclosure provides a flexible splicable light-emitting apparatus, including: at least two flexible light-emitting units and at least two node devices configured to series-connect any two of the flexible light-emitting units in series. Each of the flexible light-emitting units includes: a flexible base and a light-emitting component arranged on the flexible base and being capable of emitting a preset color, brightness, and flicker frequency according to control instructions. Two terminals of each of the flexible light-emitting units are electrically matched with interfaces of the node devices, and two or more of the flexible light-emitting units are electrically connected through the node devices. In addition, as shown in FIG. 2 and FIG. 3, a combination of the node devices and the flexible light-emitting units forms a preset pattern with intersection points. Any one of the intersection points is an intersection point formed by a series connection of at least two flexible light-emitting units and the node device.

In a color display control process of the preset pattern, the node device is configured to send the control instruction to at least one of the connected flexible light-emitting units according to a color display instruction, such that the light-emitting component in any series-connected flexible light-emitting unit in the pattern emits an adjustable color, brightness and/or flicker frequency. The color display instruction is an instruction sent by a user to all of the node devices in the pattern by an electronic device, or the color display instruction is an instruction generated by a control device in a control system of the light-emitting apparatus according to a preset program.

In view of a low degree of freedom of an existing light-emitting apparatus in the prior art, the flexible splicable light-emitting apparatus is provided with multiple flexible light-emitting units and multiple node devices. Each of the node devices is at least connected to one flexible light-emitting unit, so as to control a light-emitting effect of the connected flexible light-emitting unit, and is communicated with other node devices through the connected flexible light-emitting unit. The flexible light-emitting units are spliced and combined by the node devices to form a regular-shaped light-emitting area satisfying a preset pattern, which expands the light-emitting pattern and improve editability of the light-emitting apparatus. The present disclosure controls the light-emitting effect of the flexible light-emitting unit connected to the node device through the node device, thereby controlling each light-emitting control path accurately and achieving richer pattern light effects.

In order to facilitate a better understanding of the above technical solutions, the exemplary embodiments of the present disclosure are described in more detail below with reference to the accompanying drawings. Although the accompanying drawings show exemplary embodiments of the present disclosure, it should be understood that the present disclosure may be implemented in various forms and should not be limited to the embodiments set forth herein. The embodiments are provided for a more thorough understanding of the present disclosure, so as to make the scope of the present disclosure be fully conveyed to those skilled in the art.

Further, as shown in FIG. 1, each of the node devices is provided with an input terminal and a plurality of output terminals. The plurality of output terminals of any one of the node devices are connected to a first terminal of each of the flexible light-emitting units in one-to-one correspondence. Except for a first node device, the input terminal of any one of other node devices is connected to a second terminal of a previous flexible light-emitting unit. There is no node device on the side of the input terminal of the first node device. The node device uses a pin interface at the input terminal, and a female socket interface at the output terminal. The node device is provided with a MCU inside, which controls various light effects of the connected flexible light strip, and can exchange data with other node devices or controllers.

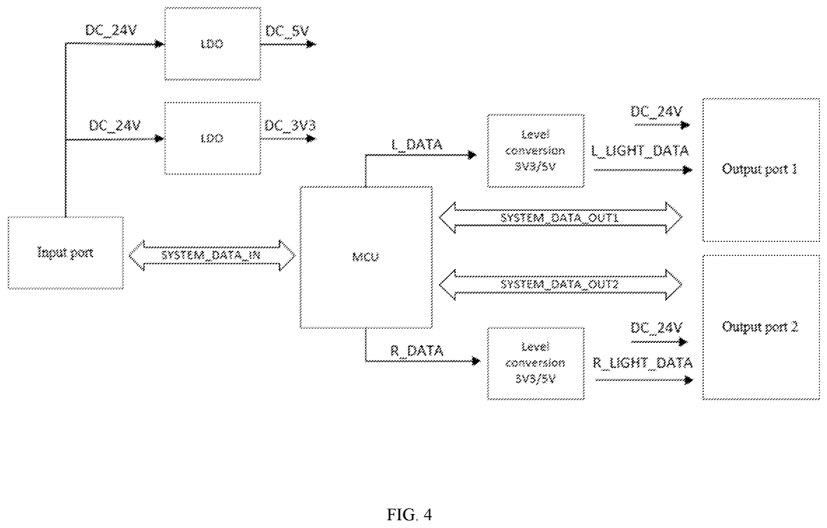

As shown in FIG. 4, the node device includes: the MCU of the node device, and a LDO circuit and a level conversion circuit connected to the MCU of the node device. The LDO circuit is configured to output a 5 V DC supplied to the level conversion circuit and a 3.3 V DC supplied to the MCU of the node device. The level conversion circuit is configured to convert a 3.3 V signal of the flexible light-emitting unit connected to the node device into a 5 V signal. Preferably, the node device has one input port and two output ports.

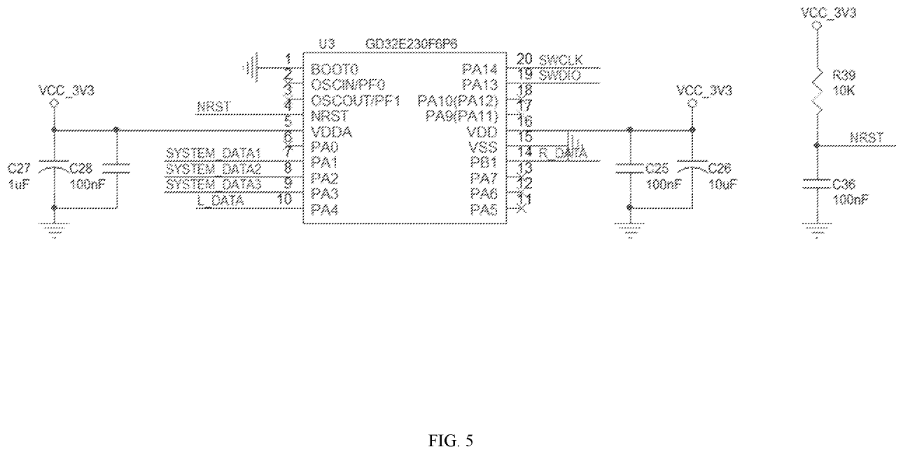

The MCU of the node device is configured to control the connected flexible light-emitting unit to change various light effects, and to communicate and exchange data with other node devices. As shown in FIG. 5, the MCU of the node device includes: a control chip with a model of GD32E230F6P6, a twenty-fifth capacitor C25, a twenty-sixth capacitor C26, a twenty-seventh capacitor C27, a twenty-eighth capacitor C28, a thirty-sixth capacitor C36, and a thirty-ninth resistor R39. An analog voltage pin of the control chip of GD32E230F6P6 is connected to a 3.3 V power supply terminal, one terminal of the twenty-seventh capacitor C27, and one terminal of the twenty-eighth capacitor C28. A power voltage pin of the control chip of GD32E230F6P6 is connected to the 3.3 V power supply terminal, one terminal of the twenty-fifth capacitor C25, and one terminal of the twenty-sixth capacitor C26. A reset pin of the control chip of GD32E230F6P6 is connected to one terminal of the thirty-ninth resistor R39 and one terminal of the thirty-sixth capacitor C36, and the other terminal of the thirty-ninth resistor R39 is connected to the 3.3 V power supply terminal. The other terminal of the twenty-seventh capacitor C27, the other terminal of the twenty-eighth capacitor C28, the other terminal of the twenty-fifth capacitor C25, and the other terminal of the twenty-sixth capacitor C26 are all grounded. The control chip of GD32E230F6P6 outputs two light-effect control signals: R_DATA and L_DATA.

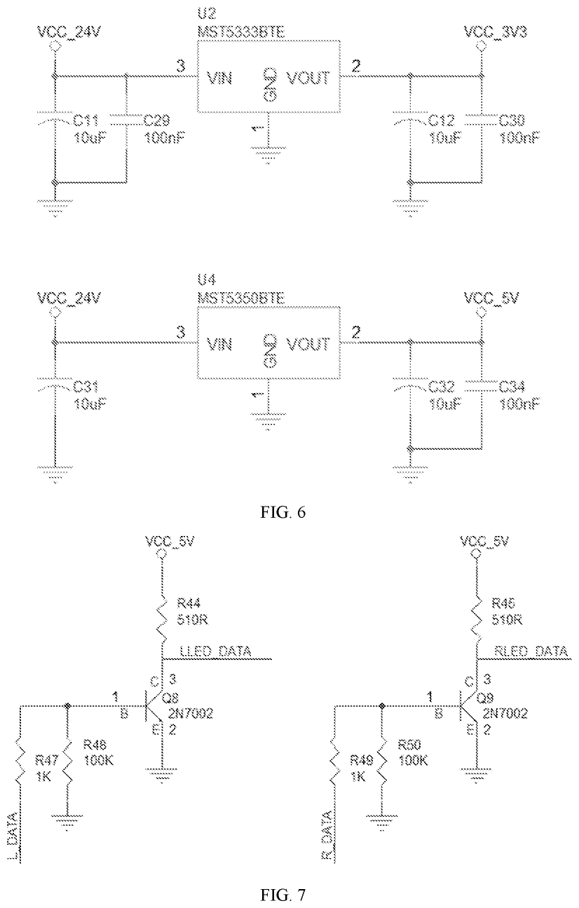

As shown in FIG. 6, the LDO circuit includes: a 5 V output sub-circuit and a 3.3 V output sub-circuit. The 3.3 V output sub-circuit includes a 24 V voltage input terminal, a 3.3 V power supply terminal, a first three-terminal voltage regulator (MST5333BTE), an eleventh capacitor C11, a twelfth capacitor C12, a twenty-ninth capacitor C29, and a thirtieth capacitor C30. The first three-terminal voltage regulator has an input terminal connected to the 24 V voltage input terminal, one terminal of the eleventh capacitor C11, and one terminal of the twenty-ninth capacitor C29, and an output terminal connected to one terminal of the twelfth capacitor C12, one terminal of the thirtieth capacitor C30, and the 3.3 V power supply terminal. The other terminal of the eleventh capacitor C11, the other terminal of the twenty-ninth capacitor C29, a ground terminal of the first three-terminal voltage regulator, the other terminal of the twelfth capacitor C12, and the other terminal of the thirtieth capacitor C30 are all grounded. The 5 V output sub-circuit includes a 24 V voltage input terminal, a 5 V power supply terminal, a second three-terminal voltage regulator (MST535OBTE), a thirty-first capacitor C31, a thirty-second capacitor C32, and a thirty-fourth capacitor C34. The second three-terminal voltage regulator has an input terminal connected to the 24 voltage input terminal and one terminal of the thirty-first capacitor, and an output terminal connected to one terminal of the thirty-second capacitor C32, one terminal of the thirty-fourth capacitor C34, and the 5V power supply terminal. The other terminal of the thirty-first capacitor C31, a ground terminal of the second three-terminal voltage regulator, the other terminal of the thirty-second capacitor C32, and the other terminal of the thirty-fourth capacitor C34 are all grounded.

As shown in FIG. 7, the level conversion circuit includes a first level conversion sub-circuit and a second level conversion sub-circuit with the same circuit structure. The first level conversion sub-circuit includes a forty-fourth resistor R44, an eighth triode Q8, a forty-seventh resistor R47, a forty-eighth resistor R48, and an output terminal of conversion signals. One terminal of the forty-fourth resistor R44 is connected to the 5 V power supply terminal. A collector of the eighth transistor Q8 is connected to the other terminal of the forty-fourth resistor R44 and the output terminal of the conversion signals. A base of the eighth triode Q8 is connected to one terminal of the forty-seventh resistor R47 and one terminal of the forty-eighth resistor R48. The other terminal of the forty-seventh resistor R47 is connected to the flexible light strip. The other terminal of the forty-eighth resistor R48 and an emitter of the eighth triode Q8 are both grounded. The second level conversion sub-circuit includes a forty-fifth resistor R45, a ninth triode Q9, a forty-ninth resistor R49, a fiftieth resistor R50, and an output terminal of conversion signals. One terminal of the forty-fifth resistor R45 is connected to the 5 V power supply terminal. A collector of the ninth transistor Q9 is connected to the other terminal of the forty-fifth resistor R45 and the output terminal of the conversion signals. A base of the ninth transistor Q9 is connected to one terminal of the forty-ninth resistor R49 and one terminal of the fifty-ninth resistor R50. The other terminal of the forty-ninth resistor R49 is connected to the flexible light strip. The other terminal of the fifty-ninth resistor R50 and an emitter of the ninth transistor Q9 are both grounded.

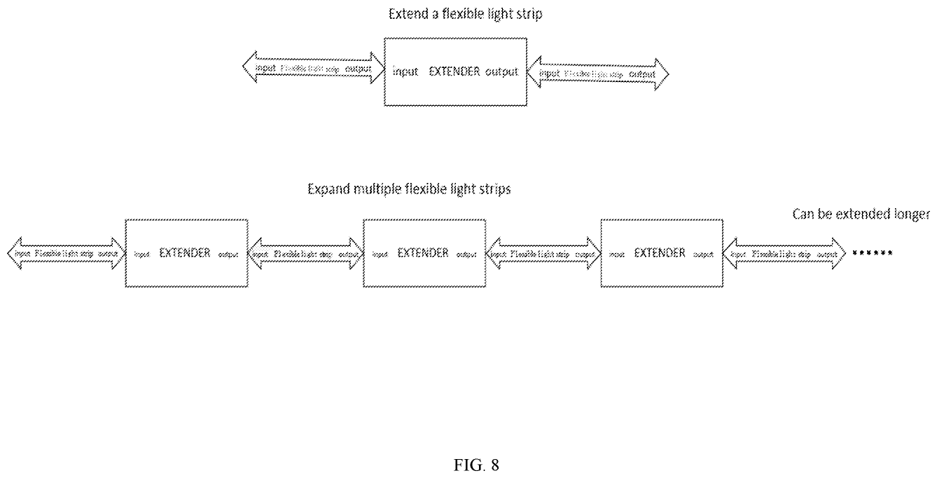

Furthermore, the light-emitting apparatus is further provided with: an extender configured to extend a length of a light-emitting display line by connecting two of the flexible light-emitting units. As shown in FIG. 8, the extender includes: a pin and a female socket.

If the preset pattern has a line with a linear distance greater than a preset length and displays a same color, the flexible light-emitting units are connected using the extender to form a light-emitting area of the line.

If the preset pattern has a line with a linear distance greater than the preset length and does not display a same color, the flexible light-emitting units are connected using the node device to form a light-emitting area of the line.

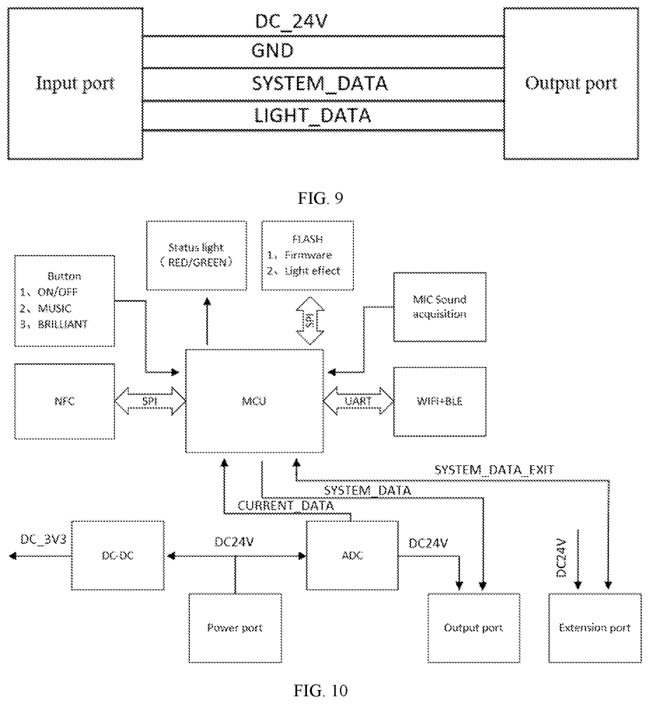

Then, two terminals of each of the flexible light-emitting units are provided with an interface device configured to connect the node device and/or the extender. Each flexible light strip can be extended in length, and the entire system can be cascaded with other kits, providing users with the possibility to create patterns in larger areas. The interface device includes a pin and a female socket. The interface device is provided with 4-core signal lines, namely, a power line, a system data line, a lighting data line, and a ground line respectively. As shown in FIG. 9, the extender is configured to transfer four signals from the previous flexible light-emitting unit to the next flexible light-emitting unit. The four signals are a 24 V DC signal (DC 24 V), a ground signal (GND), a system data signal (SYSTEM_DATA), and a light effect signal (LIGHT_DATA).

Afterwards, the flexible light-emitting unit is a flexible light strip, and the flexible light strip can be quickly connected to other components, and the main body of the flexible light strip can be bent, such that more and richer patterns can be spliced. The flexible light strip includes a flexible base, a flexible circuit board, and a light-emitting component. The flexible base has a length of 22-28 cm. The flexible circuit board is disposed on the flexible base. The light-emitting component includes a plurality of light beads uniformly distributed in a length direction of the flexible base, and each of the light beads is connected to the flexible circuit board. The light-emitting apparatus is allowed to be provided with a maximum of 18 flexible light-emitting units. Preferably, the light beads are magic colored light beads.

In a specific embodiment, the flexible light-emitting unit electrically includes: where the DC-DC power supply steps down DC 24 V to DC 5 V to supply power to the light beads. The light beads are light sources in the system, which can achieve various light effects. The interface devices at two terminals of the flexible light-emitting unit are the pins and the female sockets, which are configured to connect the node device or extend the length of the flexible light-emitting unit. Four signals coming from the input interface are DC 24 V, GND, SYSTEM_DATA, and LIGHT_DATA, of which DC 24 V, GND, and LIGHT_DATA will be connected to the light beads to generate lights. The output interface will output DC 24 V, GND, SYSTEM_DATA, and LIGHT_DATA_OUT (the output data of the last light bead) to the next level.

Moreover, the present disclosure further provides a flexible splicable light-emitting system, including: a controller and the flexible splicable light-emitting apparatus connected to the controller as described above that are arranged in pairs.

In the controller and the light-emitting apparatus arranged in a same pair, the controller is connected to one of the node devices of the light-emitting apparatus, and is communicated with other node devices through the connected node device. The controller obtains a serial number and port connection status information of the connected node device, and assigns and writes a corresponding control address to the connected node device according to the serial number and the port connection status information of the connected node device. The controller obtains a serial number and port connection status information of an adjacent node device of the connected node device through the connected node device, and assigns and writes a corresponding control address to the adjacent node device according to the serial number and the port connection status information of the adjacent node device. The controller expands step by step to acquire serial numbers and port connection status information of all of the node devices in the light-emitting system, and assigns and writes a corresponding control address to each of the node devices. The controller controls lighting of the light beads on the flexible light-emitting units connected to each of the node devices, performs a current detection operation on all of the light beads on each of the flexible light-emitting units, and determines an effective length of each of the flexible light-emitting units according to a number of light beads that obtain a current. The controller obtains a topology satisfying the preset pattern according to the control addresses of all of the node devices and the effective lengths of the flexible light-emitting units connected to all ports of each of the node devices. The controller controls the light-emitting effect of each of the flexible light-emitting units through the node devices to form a light-emitting area based on the topology. The effective length of each of the flexible light-emitting units is a light-emitting length of each of the flexible light-emitting units capable of being lit. Preferably, there is a current measuring unit in the controller, which can count the length of each light strip, and when a total power reaches an upper limit of the system, the system will automatically reduce the brightness of the flexible light strip.

After the flexible splicable light-emitting apparatus is powered on, the controller sends an instruction to query a topology connected to the node device of the apparatus, and sequentially control the flexible light-emitting units connected to each of the node devices to light up according to the topology. At this time, the controller monitors the current and lights up the flexible light-emitting units quickly by taking each flexible light-emitting unit as a group (12 light beads), and determines whether there is a flexible light-emitting unit at each interface of the node device, and how many times has the flexible light-emitting unit been extended using the current of the apparatus. At the same time, the controller will also acquire the number of node devices, and mark the address of the node device. Subsequently, it can send a control instruction to the node device, and the node device can also return data to the controller. The apparatus uses a single-wire bidirectional communication method, and the data of the apparatus is transferred from the previous level to the next level. If it is the data of the node device, it will be processed. If it is not, it will continue to be transferred to the next level.

Further, the controller acquires a sound amplitude and/or a sound frequency within a preset range. The controller controls each of the flexible light-emitting units in the light-emitting apparatus to display corresponding light-emitting brightness according to the sound amplitude, and controls each of the flexible light-emitting units in the light-emitting apparatus to display a corresponding light-emitting color according to the sound frequency.

Further, the flexible splicable light-emitting system is further provided with a remote terminal. The controller also exchanges data with the remote terminal through WIFI and/or Bluetooth, and controls the light-emitting effect of each of the flexible light-emitting units according to a control instruction fed back by the remote terminal. The remote terminal includes: a non-portable terminal and a portable terminal. The non-portable terminal includes: one or more of distributed network devices/systems, server/server groups, and desktop computers. The portable terminal includes: one or more of laptops, smartphones, and tablets.

As shown in FIG. 10, the controller includes: a MCU of the controller, and a WIFI circuit, a NFC circuit, a FLASH circuit, a MIC acquisition circuit, and a DC-DC power circuit connected to the controller. Further, the controller can also sample the current.

In a specific embodiment, the circuit units of the controller include: the DC-DC power supply is configured to convert the DC 24 V voltage into DC 3.3 V, which is supplied to various signal processing circuits in the controller system; the WIFI circuit is configured to communicate with the Ethernet, and exchange device data and control instructions; the NFC circuit is configured to transfer the user name and password of a router when the device is added with a WIFI network; a FLASH circuit board is configured to store various light effect data and system firmware; the MIC acquisition circuit is configured to acquire the rhythm in ambient music, so as to control the synchronous rhythm of the light; a button circuit is used for the near-field operation of device switches and light mode selection; a current sampling circuit is used to count the length of each light strip and detect the system current; and the MCU circuit, as the main core control part of the system, is responsible for interaction between system data and the outside world, statistics of system topology, output of various light effect data, and processing of acousto-optic rhythm.

Further, after the MIC acquisition function is enabled, the MIC acquires the ambient sound, amplifies an audio signal through the operational amplifier, and then sends it to an analog-digital (AD) input port of the MCU for data sampling. The rhythmic brightness of the flexible light-emitting unit is controlled by acquiring the amplitude in the ambient sound, and the rhythmic color of the flexible light-emitting unit is controlled by acquiring the frequency in the ambient sound.

Further, when a mobile phone with a NFC function is used to add a device, first the user name and password of the router are added to the app of the light-emitting apparatus, then a device adding page is entered, and then an on-off key on the controller is pressed long to make the device enter a factory reset state. At this time, the mobile phone is moved within 10 mm of the front of the controller, and the mobile phone will transfer the user name and password of the router to the controller through NFC, and the controller will then obtain the WIFI information and then connect the WIFI network. The use of the NFC distribution network can simplify a device addition process and increase the success rate of the distribution network.

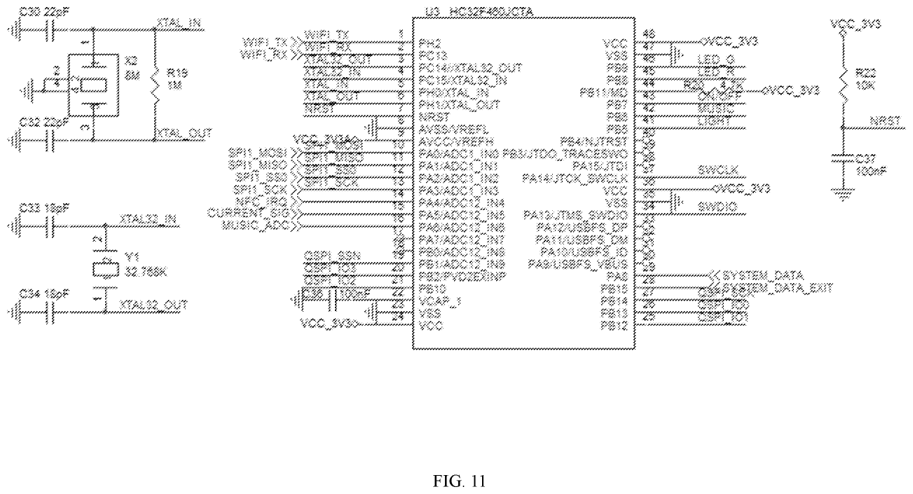

Further, as shown in FIG. 11, the MCU of the controller includes a control chip with a model of HC32F460JCTA and its peripheral circuits.

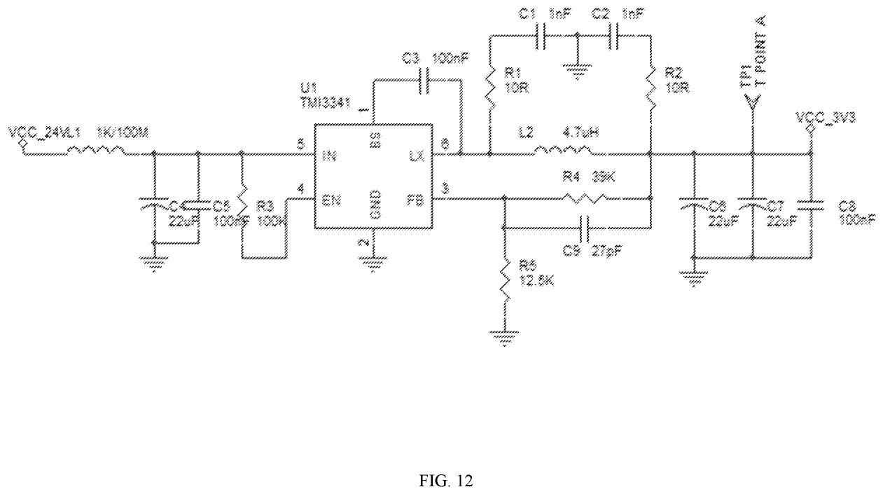

As shown in FIG. 12, the DC-DC power circuit includes a step-down chip (TMI3341), a 24 V voltage input terminal, a first inductor L1, a second inductor L2, a first capacitor C1, a second capacitor C2, a third capacitor C3, a four capacitor C4, a fifth capacitor C5, a sixth capacitor C6, a seventh capacitor C7, an eighth capacitor C8, a ninth capacitor C9, a first resistor R1, a second resistor R2, a third resistor R3, a fourth resistor R4, a fifth resistor R5, and a 3.3 V power supply terminal. An input pin of the step-down chip is connected to a first terminal of the first inductor L1, one terminal of the fourth capacitor C4, one terminal of the fifth capacitor C5, and one terminal of the third resistor R3, and the other terminal of the fourth capacitor C4 and the other terminal of the fifth capacitor C5 are grounded. An enable pin of the step-down chip is connected to the other terminal of the third resistor R3. A self-boosting pin of the step-down chip is connected to one terminal of the third capacitor C3. An output pin of the step-down chip is connected to the other terminal of the third capacitor C3, one terminal of the first resistor R1, and one terminal of the second inductor L2. The other terminal of the first resistor R1 is connected to one terminal of the first capacitor C1. The other terminal of the first capacitor C1 is connected to one terminal of the second capacitor C2. The other terminal of the second capacitor C2 is connected to one terminal of the second resistor R2. The other terminal of the second resistor R2 is connected to the other terminal of the second inductor L2, the other terminal of the fourth resistor R4, one terminal of the sixth capacitor R6, one terminal of the seventh capacitor R7, one terminal of the eighth capacitor R8, one terminal of the ninth capacitor R9, and the 3.3 V power supply terminal. A feedback pin of the step-down chip is connected to one terminal of the fourth resistor R4, one terminal of the ninth capacitor R9, and one terminal of the fifth resistor R5. A ground pin of the step-down chip, the other terminal of the sixth capacitor C6, the other terminal of the seventh capacitor C7, and the other terminal of the eighth capacitor C8 are all grounded.

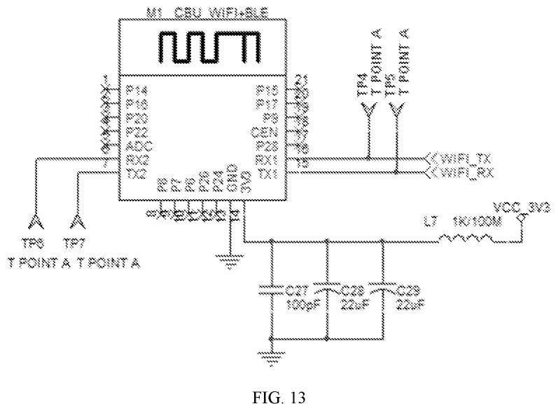

As shown in FIG. 13, the WIFI circuit includes a radio frequency (RF) chip (CBU), a seventh inductor L7, a twenty-seventh capacitor C27, a twenty-eighth capacitor C28, and a twenty-ninth capacitor C29. One terminal of the seventh inductor L7 is connected to an output terminal of the DC-DC power circuit, and the other terminal of the seventh inductor L7 is connected to one terminal of the twenty-seventh capacitor C27, one terminal of the twenty-eighth capacitor C28, one terminal of the twenty-ninth capacitor C29, and a power input pin of the RF chip. A ground pin of the RF chip, the other terminal of the twenty-seventh capacitor C27, the other terminal of the twenty-eighth capacitor C28, and the other terminal of the twenty-ninth capacitor C29 are all grounded.

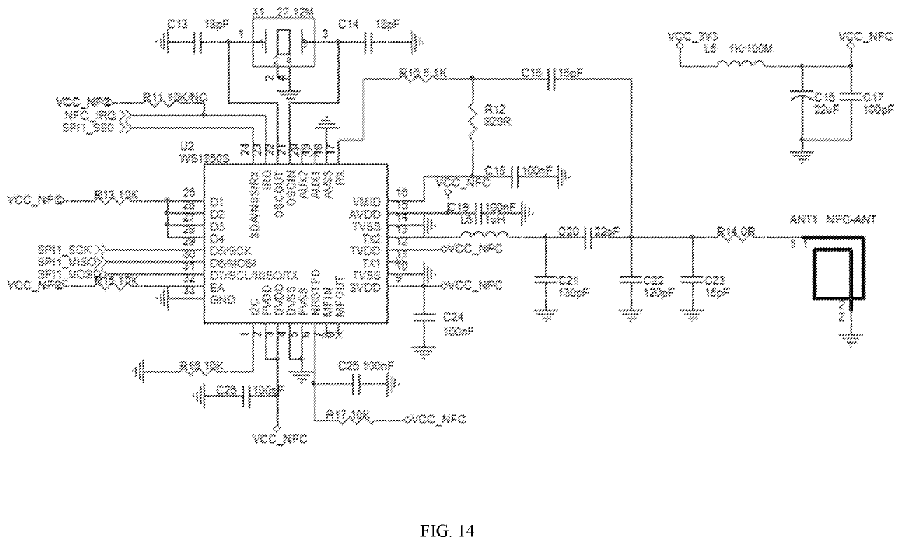

As shown in FIG. 14, the NFC circuit includes a RF card reader chip (WS1850S), a tenth resistor R10, an eleventh resistor R11, a twelfth resistor R12, a fourteenth resistor R14, a fifteenth resistor R15, a sixteenth resistor R16, a seventeenth resistor R17, a thirteenth capacitor C13, a fourteenth capacitor C14, a fifteenth capacitor C15, a sixteenth capacitor C16, a seventeenth capacitor C17, an eighteenth capacitor C18, a nineteenth capacitor C19, a twentieth capacitor C20, a twenty-first capacitor C21, a twenty-second capacitor C22, a twenty-third capacitor C23, a twenty-fourth capacitor C24, a twenty-fifth capacitor C25, a twenty-sixth capacitor C26, a fifth inductor L5, a sixth inductor L6, a crystal oscillator X1, an antenna ANT 1, and a NFC power supply terminal.

The NFC power supply terminal is connected to one terminal of the sixteenth capacitor C16, one terminal of the seventeenth capacitor C17, and one terminal of the fifth inductor L5. The other terminal of the fifth inductor L5 is connected to the 3.3 V power supply terminal of the DC-DC power circuit, and the other terminal of the sixteenth capacitor C16 and the other terminal of the seventeenth capacitor C17 are both grounded. A first parallel port communication interface, a second parallel port communication interface, a third parallel port communication interface, a fourth parallel port communication interface, and a fifth parallel port communication interface of the RF card reader chip are all connected to one terminal of the thirteenth resistor R13. The other terminal of the thirteenth resistor R13 is connected to the NFC power supply terminal. The fifth parallel port communication interface, a sixth parallel port communication interface, and a seventh parallel port communication interface of the RF card reader chip are all connected to the MCU of the controller. An enable pin of the RF card reader chip is connected to one terminal of the fifteenth resistor R15, and the other terminal of the fifteenth resistor R15 is connected to the NFC power supply terminal. A GND pin of the RF card reader chip is grounded. An inter-integrated circuit (I2C) pin of the RF card reader chip is connected to one terminal of the sixteenth resistor R16, and the other terminal of the sixteenth resistor R16 is grounded. A pin power pin and a digital power pin of the RF card reader chip are connected to one terminal of the twenty-sixth capacitor C26 and the NFC power supply terminal at the same time, and the other terminal of the twenty-sixth capacitor C26 is grounded. The digital ground pin and pin power ground of the RF card reader chip are all grounded. A reset pin of the RF card reader chip is connected to one terminal of the twenty-fifth capacitor C25 and one terminal of the seventeenth resistor R17, and the other terminal of the twenty-fifth capacitor C25 is grounded, and the other terminal of the seventeenth resistor R17 is connected to the NFC power supply terminal. A signal power pin of the RF card reader chip is connected to the NFC power supply terminal and one terminal of the twenty-fourth capacitor C24, and the other terminal of the twenty-fourth capacitor C24 is grounded. An emitter ground pin of the RF card reader chip is grounded. An emitter power pin of the RF card reader chip is connected to the NFC power supply terminal. An emitter pin of the RF card reader chip is connected to one terminal of the sixth inductor L6. The other terminal of the sixth inductor L6 is connected to one terminal of the twentieth capacitor C20 and one terminal of the twenty-first capacitor C21. The other terminal of the twentieth capacitor C20 is connected to one terminal of the fifteenth capacitor C15, one terminal of the twenty-second capacitor C22, one terminal of the twenty-third capacitor C23, and one terminal of the fourteenth resistor R14. The other terminal of the twenty-first capacitor C21, the other terminal of the twenty-second capacitor C22, and the other terminal of the twenty-third capacitor C23 are all grounded. The other terminal of the fourteenth resistor R14 is connected to one terminal of the antenna ANTI, and the other terminal of the antenna ANT1 is grounded. An analog power pin of the RF card reader chip is connected to the NFC power supply terminal and a first terminal of the nineteenth capacitor C19, and the other terminal of the nineteenth capacitor C19 is grounded. A reference voltage pin of the RF card reader chip is connected to one terminal of the twelfth resistor R12 and one terminal of the eighteenth capacitor C18, and the other terminal of the eighteenth capacitor C18 is grounded. A signal input pin of the RF card reader chip is connected to one terminal of the tenth resistor R10, and the other terminal of the tenth resistor R10 is connected to the other terminal of the twelfth resistor R12 and the other terminal of the fifteenth capacitor C15. An analog ground pin of the RF card reader chip is grounded. A crystal oscillator input pin of the RF card reader chip is connected to a first terminal of the crystal oscillator and a first terminal of the fourteenth capacitor C14, and the other terminal of the fourteenth capacitor C14 is grounded.

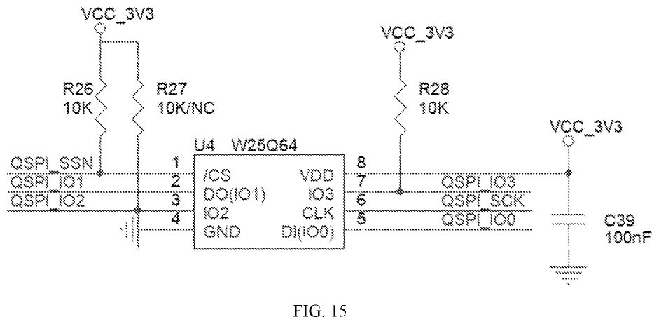

As shown in FIG. 15, the FLASH circuit includes a flash memory chip, a twenty-sixth resistor R26, a twenty-seventh resistor R27, a twenty-eighth resistor R28, and a thirty-ninth capacitor C39. The 3.3 V power supply terminal of the DC-DC power circuit is connected to one terminal of the twenty-sixth resistor R26, one terminal of the twenty-seventh resistor R27, and one terminal of the twenty-eighth resistor R28. A chip select input pin of the flash memory chip is connected to the other terminal of the twenty-sixth resistor R26 and the MCU of the controller. A data output pin of the flash memory chip is connected to the MCU of the controller. The write input protection of the flash memory chip is connected to the MCU of the controller. A ground pin of the flash memory chip is grounded. A data input pin of the flash memory chip is connected to the MCU of the controller. A serial clock input pin of the flash memory chip is connected to the MCU of the controller. A hold input pin is connected to the other terminal of the twenty-eighth resistor R28 and the MCU of the controller. A power pin of the flash memory chip is connected to the 3.3 V power supply terminal of the DC-DC power circuit and one terminal of the thirty-ninth capacitor C39, and the other terminal of the thirty-ninth capacitor C39 is grounded.

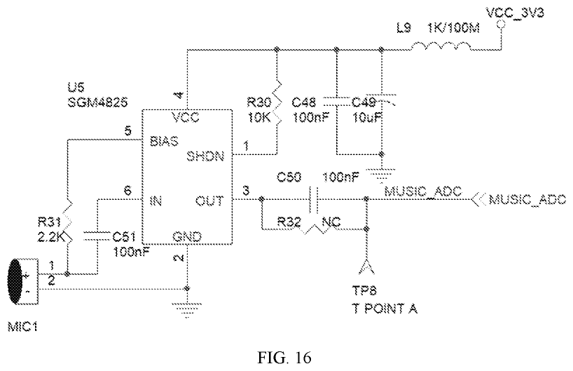

As shown in FIG. 16, the MIC acquisition circuit includes a microphone, a microphone amplifier chip, a thirtieth resistor R30, a thirty-first resistor R31, a thirty-second resistor R32, a forty-eighth capacitor C48, a forty-ninth capacitor C49, a fiftieth capacitor C50, a fifty-first capacitor C51, and a ninth inductor L9. A first terminal of the microphone is connected to one terminal of the thirty-first resistor R31 and one terminal of the fifty-first capacitor C51. A second terminal of the microphone is grounded. A turn-off control pin of the microphone amplifier chip is connected to the other terminal of the thirtieth resistor R30, a ground pin of the microphone amplifier chip is grounded, an amplifier output pin of the microphone amplifier chip is connected to one terminal of the fiftieth capacitor C50 and one terminal of the thirty-second resistor R32, and the other terminal of the fiftieth capacitor C50 and the other terminal of the thirty-second resistor R32 are connected to the MCU of the controller. A power pin of the microphone amplifier chip is connected to one terminal of the thirtieth resistor R30, one terminal of the forty-eighth capacitor C48, one terminal of the forty-ninth capacitor C49, and one terminal of the ninth inductor L9, the other terminal of the forty-eighth capacitor C48 and the other terminal of the forty-ninth capacitor C49 are grounded, and the other terminal of the ninth inductor L9 is connected to the 3.3 V power supply terminal of the DC-DC power circuit. A bias output pin of the microphone amplifier chip is connected to the other terminal of the thirty-first resistor R31. An amplifier input pin of the microphone amplifier chip is connected to the other terminal of the fifty-first capacitor C51.

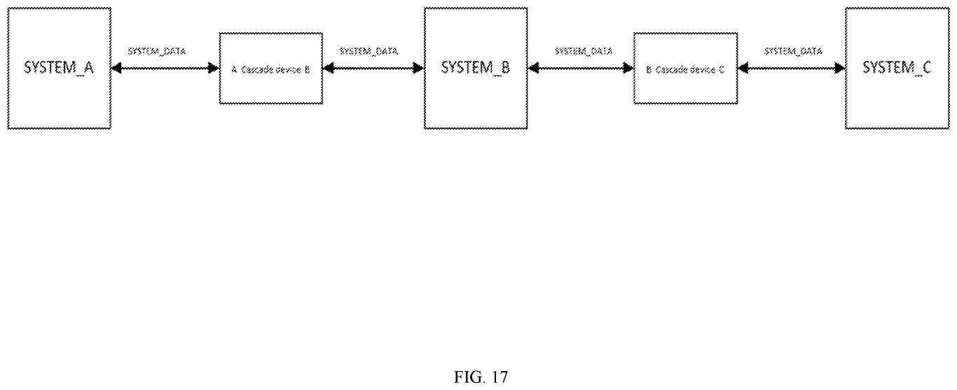

Further, as shown in FIG. 17, when multiple sets of accessories are needed to complete the splicing of large-scale patterns, the light-emitting system further includes: a cascade device for communication between a plurality of light-emitting apparatuses, and communication between every two light-emitting apparatuses is performed through the cascade device. In the embodiment of the present disclosure, the cascade device includes: two LDO power circuits which each output DC 3.3 V for supplying power to an isolated single-wire bidirectional communication circuit. The isolated single-wire bidirectional communication circuit is mainly used for mutual communication between two cascaded light-emitting apparatuses, and is completely electrically isolated from the two light-emitting apparatuses.

Further, the cascade device includes: two LDO power circuits and the isolated single-wire bidirectional communication circuit. The two LDO power circuits are configured to supply 3.3 V to the isolated single-wire bidirectional communication circuit. The isolated single-wire bidirectional communication circuit is used for communication between cascaded light-emitting apparatuses.

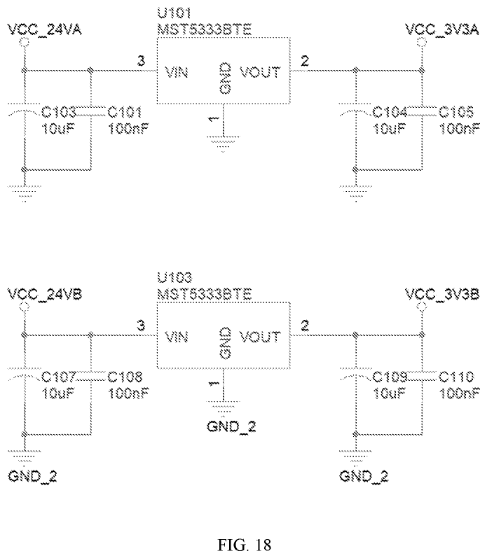

As shown in FIG. 18, the two LDO power circuits include a first power sub-circuit and a second power sub-circuit with the same circuit structure. The first power sub-circuit includes a three-terminal voltage regulator (MST5333BTE), a 24 V voltage input terminal, a one hundred and first capacitor C101, a one hundred and third capacitor C103, a one hundred and fourth capacitor C104, a one hundred and fifth capacitor C105, and a first 3.3 V power supply terminal. The three-terminal voltage regulator has an input terminal connected to the 24 V voltage input terminal, a first terminal of the one hundred and first capacitor C101, and a first terminal of the one hundred and third capacitor C103, and an output terminal connected to one terminal of the one hundred and fourth capacitor C104, one terminal of the one hundred and fifth capacitor C105, and the first 3.3 V power supply terminal. The other terminal of the one hundred and first capacitor C101, the other terminal of the one hundred and third capacitor C103, a ground terminal of the three-terminal voltage regulator, the other terminal of the one hundred and fourth capacitor C104, and the other terminal of the one hundred and fifth capacitor C105 are all grounded. The second power sub-circuit includes a three-terminal voltage regulator (MST5333BTE), a 24 V voltage input terminal, a one hundred and seventh capacitor C107, a one hundred and eighth capacitor C108, a one hundred and ninth capacitor C109, a one hundred and tenth capacitor C110, and a second 3.3 V power supply terminal. The three-terminal voltage regulator has an input terminal connected to the 24 V voltage input terminal, a first terminal of the first one hundred and seventh capacitor C107, and a first terminal of the one hundred and eighth capacitor C108, and an output terminal connected to one terminal of the one hundred and ninth capacitor C109, one terminal of the one hundred and tenth capacitor C110, and the second 3.3 V power supply terminal. The other terminal of the one hundred and seventh capacitor C107, the other terminal of the one hundred and eighth capacitor C108, a ground terminal of the three-terminal voltage regulator, the other terminal of the one hundred and ninth capacitor C109, and the other terminal of the one hundred and tenth capacitor C110 are all grounded.

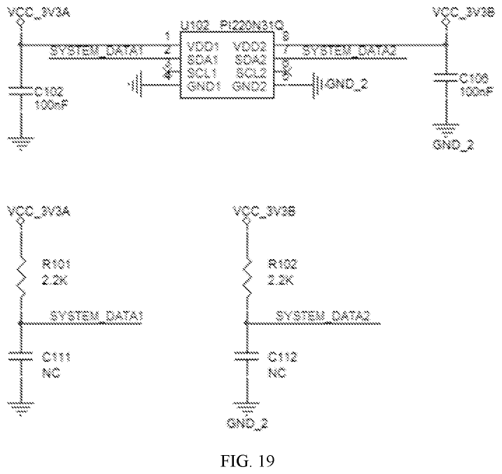

As shown in FIG. 19, the isolated single-wire bidirectional communication circuit includes: an isolated communication chip, a one hundred and second capacitor C102, a one hundred and sixth capacitor C106, a one hundred and eleventh capacitor C111, and a one hundred and twelfth capacitor C112, a one hundred and first resistor R101, and a one hundred and second resistor R102. The isolated communication chip has a first power pin connected to the first 3.3 V power supply terminal and one terminal of the one hundred and second capacitor C102, and a second power pin connected to the second 3.3 V power supply terminal and one terminal of the one hundred and sixth capacitor C106. First and second data pins of the isolated communication chip are connected to a data pin of a first light-emitting apparatus and a data pin of a second light-emitting apparatus respectively. The data pin of the first light-emitting apparatus is also connected to one terminal of the one hundred and first resistor R101 and one terminal of the one hundred and eleventh capacitor C111, the other terminal of the one hundred and first resistor R101 is connected to the first 3.3 V power supply terminal, and the other terminal of the one hundred and eleventh capacitor C111 is grounded. The data pin of the second light-emitting apparatus is also connected to one terminal of the one hundred and second resistor R102 and one terminal of the one hundred and twelfth capacitor C112, the other terminal of the one hundred and second resistor R102 is connected to the second 3.3 V power supply terminal, and the other terminal of the one hundred and twelfth capacitor C112 is grounded. The other terminal of the one hundred and second capacitor C102, the other terminal of the one hundred and six capacitor C106, and a ground pin of the isolated communication chip are all grounded.

In addition, the present disclosure further provides a control method for a flexible splicable light-emitting apparatus, applied to the flexible splicable light-emitting apparatus as described above, and including:

S1, A serial number and port connection status information of a node device are obtained, and a corresponding control address is assigned and written to the node device according to the serial number and the port connection status information of the node device.

S2, A serial number and port connection status information of an adjacent node device of the node device are obtained through the node device, and a corresponding control address is assigned and written to the adjacent node device according to the serial number and the port connection status information of the adjacent node device.

S3, Expansion is performed step by step to acquire serial numbers and port connection status information of all of the node devices in a light-emitting system, and a corresponding control address is assigned and written to each of the node devices.

S4, Lighting of the light beads on the flexible light-emitting units connected to each of the node devices is controlled, a current detection operation is performed on all of the light beads on each of the flexible light-emitting units, and an effective length of each of the flexible light-emitting units is determined according to a number of light beads that obtain a current.

S5, A topology satisfying the preset pattern is obtained according to the control addresses of all of the node devices and the effective lengths of the flexible light-emitting units connected to all ports of each of the node devices.

S6, A light-emitting effect of each of the flexible light-emitting units are controlled through the node devices to form a light-emitting area based on the topology.

The effective length of each of the flexible light-emitting units is a light-emitting length of each of the flexible light-emitting units capable of being lit.

Further, the method includes the following steps.

S7, A sound amplitude and/or a sound frequency within a preset range are/is acquired.

S8, Each of the flexible light-emitting units in the light-emitting apparatus is controlled to display corresponding light-emitting brightness according to the sound amplitude, and each of the flexible light-emitting units in the light-emitting apparatus is controlled to display a corresponding light-emitting color according to the sound frequency.

To sum up, the present disclosure provides a flexible splicable light-emitting apparatus and system and a control method. Each flexible light-emitting unit has a length of 22-28 cm, an extender can be used to increase the length of the flexible light-emitting unit, and a single light-emitting apparatus is allowed to be provided with a maximum of 18 flexible light-emitting units. If the spliced pattern exceeds 18 flexible light-emitting units, a cascade device can be used to expand another set or multiple sets of light-emitting apparatuses. There is complete electrical isolation between light-emitting apparatuses. The node device and the controller, as well as the cascade system exchange system data through single-wire bidirectional communication. The light effect data is sent by the MCU of the controller to the MCU of the corresponding node device through single-wire bidirectional communication, and then the MCU of the node device specifically controls the corresponding flexible light-emitting unit to change the light.

Based on the above solution, it can be seen that aiming at the editability of the pattern, the present disclosure uses the segmented flexible light-emitting units which can be bent into different shapes. The light strip interface can be quickly spliced with the pin and the female socket with good fast connection, and for lighting of the light strip, the light beads are used to control the color of each light-emitting point individually. When the pattern branch needs to be expanded, the node device can be used to increase the branch. If the length of a single light strip is not enough, the length of the series of light strips can be increased by the extender. When encountering very large patterns, cascading adapters can be used to quickly expand one or more sets of accessories, so as to splice out more colorful patterns. At the same time, during the system power-on self-test, the number of node devices will be acquired, and it will be detected whether the branch of the node device is connected to a light strip and how long the light strip is to present the entire splicing pattern on the app and allow users to edit the static and dynamic light effects of each light strip on the app.

Since the system/apparatus described in the above embodiments of the present disclosure is the system/apparatus used for implementing the above embodiments of the present disclosure, based on the method described in the above embodiments of the present disclosure, those skilled in the art can understand the specific structure and modification of the system/apparatus, so it is not repeated here. The system/apparatus used in the method of the above embodiments of the present disclosure belongs to the scope of protection of the present disclosure.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, CD-ROM, an optical memory, and the like) that include a computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams.

It should be noted that, in the claims, any reference signs placed between parentheses shall not be construed as limiting the claim. The word “include” does not exclude the presence of components or steps not listed in the claims. The word “a/an” or “one” preceding an element does not exclude the existence of multiple such components. The present disclosure can be implemented with the assistance of hardware including multiple different components and the assistance of a properly programmed computer. In the claims where multiple apparatuses are listed, multiple of the apparatuses may be embodied by the same hardware item. The words first, second, third, etc. are used for convenience of expression only and do not imply any order. These words can be understood as part of the component name.

In addition, it should be noted that in the description of this specification, the description with reference to the terms such as “one embodiment”, “some embodiments”, “embodiment”, “example”, “specific example” or “some examples” means that specific features, structures, materials or characteristics described in connection with the embodiment or example are included in at least one embodiment or example of the present disclosure. In this specification, schematic representation of the above terms is not necessarily directed to the same embodiment or example. Moreover, the specific features, structures, materials or characteristics described may be combined in a suitable manner in any one or more embodiments or examples. In addition, those skilled in the art may combine different embodiments or examples described in this specification and characteristics of the different embodiments or examples without mutual contradiction.

Although preferred embodiments of the present disclosure have been described, those skilled in the art can make additional alterations and modifications to these embodiments once they learn the basic inventive concept. Therefore, the appended claims are intended to be interpreted as including the preferred embodiments and all alterations and modifications falling within the scope of the present disclosure.

Obviously, those skilled in the art can make various alterations and modifications to the present disclosure without departing from the spirit and scope of the present disclosure. The present disclosure is intended to cover these modifications and variations provided that they fall within the scope of protection defined by the following claims and their equivalent technologies.

What is claimed is:

1. A flexible splicable light-emitting apparatus, comprising: at least two flexible light-emitting units and at least two node devices configured to series-connect any two of the at least two flexible light-emitting units in series, wherein
each of the at least two flexible light-emitting units comprises: a flexible base and a light-emitting component arranged on the flexible base and being configured for emitting a light with a preset color, a preset brightness, and a preset flicker frequency according to control instructions;
two terminals of each of the at least two flexible light-emitting units are electrically matched with interfaces of the at least two node devices, and two or more of the at least two flexible light-emitting units are electrically connected through the at least two node devices; a combination of the at least two node devices and the at least two flexible light-emitting units forms a preset pattern with intersection points; and any one of the intersection points is an intersection point formed by a series connection of at least two of the at least two flexible light-emitting units and one of the at least two node devices;
in a color display control process of the preset pattern, the at least two node devices are configured to send the control instructions to at least one of the at least two flexible light-emitting units connected to the at least two node devices according to a color display instruction, and the light-emitting component in any series-connected flexible light-emitting unit of the at least two flexible light-emitting units in the preset pattern emits an adjustable color, adjustable brightness and/or adjustable flicker frequency; and
the color display instruction is an instruction sent by a user to all of the at least two node devices in the preset pattern by an electronic device, or the color display instruction is an instruction generated by a control device in a control system of the flexible splicable light-emitting apparatus according to a preset program.

2. The flexible splicable light-emitting apparatus according to claim 1, wherein each of the interfaces of the at least two node devices comprises an input terminal and a plurality of output terminals;
the plurality of output terminals of any one of the at least two node devices are connected to a first terminal of each of the at least two flexible light-emitting units in one-to-one correspondence; and
except for a first node device of the at least two node devices, the input terminal of any one of other node devices of the at least two node devices is connected to a second terminal of a previous flexible light-emitting unit of the at least two flexible light-emitting units.

3. The flexible splicable light-emitting apparatus according to claim 1, wherein the flexible splicable light-emitting apparatus is further provided with an extender configured to extend a length of a light-emitting display line by connecting two of the at least two flexible light-emitting units;
if the preset pattern has a line with a linear distance greater than a preset length and displays a same color, the at least two flexible light-emitting units are connected using the extender to form a first light-emitting area of the line; and
if the preset pattern has the line with the linear distance greater than the preset length and does not display the same color, the at least two flexible light-emitting units are connected using the at least two node devices to form a second light-emitting area of the line.

4. The flexible splicable light-emitting apparatus according to claim 3, wherein the two terminals of each of the at least two flexible light-emitting units are provided with an interface device configured to connect the at least two node devices and/or the extender; and the interface device is provided with 4-core signal lines, wherein the 4-core signal lines is a power line, a system data line, a lighting data line, and a ground line respectively.

5. The flexible splicable light-emitting apparatus according to claim 1, wherein each of the at least two flexible light-emitting units is a flexible light strip, and the flexible light strip comprises the flexible base, a flexible circuit board, and the light-emitting component;
the flexible base has a length of 22-28 cm;
the flexible circuit board is disposed on the flexible base; and
the light-emitting component comprises a plurality of light beads uniformly distributed in a length direction of the flexible base, and each of the plurality of light beads is connected to the flexible circuit board.

6. The flexible splicable light-emitting apparatus according to claim 1, wherein the flexible splicable light-emitting apparatus comprises at most 18 flexible light-emitting units.

7. A flexible splicable light-emitting system, comprising: a controller and the flexible splicable light-emitting apparatus according to claim 1, wherein the controller and the flexible splicable light-emitting apparatus are arranged in pairs, wherein
in the controller and the flexible splicable light-emitting apparatus arranged in a same pair,
the controller is connected to one node device of the at least two node devices of the flexible splicable light-emitting apparatus, and the controller is communicated with other node devices of the at least two node devices through the connected one node device;
the controller obtains a serial number of the connected one node device and port connection status information of the connected one node device, and the controller assigns and writes a first control address to the connected one node device according to the serial number of the connected one node device and the port connection status information of the connected one node device;
the controller obtains a serial number of an adjacent node device of the connected one node device and port connection status information of the adjacent node device of the connected one node device through the connected one node device, and the controller assigns and writes a second control address to the adjacent node device according to the serial number of the adjacent node device and the port connection status information of the adjacent node device;
the controller expands step by step to acquire serial numbers of all of the at least two node devices and port connection status information of all of the at least two node devices in the flexible splicable light-emitting system, and the controller assigns and writes a corresponding control address to each of the at least two node devices;
the controller controls a lighting of the plurality of light beads on the at least two flexible light-emitting units connected to each of the at least two node devices, the controller performs a current detection operation on all of the plurality of light beads on each of the at least two flexible light-emitting units, and the controller determines an effective length of each of the at least two flexible light-emitting units according to a number of light beads obtaining a current;
the controller obtains a topology satisfying the preset pattern according to the control addresses of all of the at least two node devices and the effective lengths of the at least two flexible light-emitting units connected to all ports of each of the at least two node devices;
the controller controls a light-emitting effect of each of the at least two flexible light-emitting units through the at least two node devices to form a light-emitting area based on the topology; and
the effective length of each of the at least two flexible light-emitting units is a light-emitting length of each of the at least two flexible light-emitting units configured for being lit.

8. The flexible splicable light-emitting system according to claim 7, wherein:
the controller acquires a sound amplitude and/or a sound frequency within a preset range; and
the controller controls each of the at least two flexible light-emitting units in the flexible splicable light-emitting apparatus to correspondingly display a light-emitting brightness according to the sound amplitude, and the controller controls each of the at least two flexible light-emitting units in the flexible splicable light-emitting apparatus to correspondingly display a light-emitting color according to the sound frequency.

9. The flexible splicable light-emitting system according to claim 7, further comprising a remote terminal, wherein
the controller exchanges data with the remote terminal through wireless fidelity (WIFI) and/or Bluetooth, and the controller controls the light-emitting effect of each of the at least two flexible light-emitting units according to a control instruction fed back by the remote terminal; and
the remote terminal comprises: a non-portable terminal and a portable terminal; the non-portable terminal comprises: one or more of distributed network devices/systems, server/server groups, and desktop computers; and the portable terminal comprises: one or more of laptops, smartphones, and tablets.

10. The flexible splicable light-emitting system according to claim 7, further comprising:
a cascade device, wherein every two pairs of controllers and light-emitting apparatuses arranged in pairs are communicated through the cascade device;
one of the controllers in the flexible splicable light-emitting system is set as a host according to preset configuration information; and
the host is configured to obtain all node device data of any one of the light-emitting apparatuses in the flexible splicable light-emitting system through the cascade device, and the host control a color, a brightness, and a flicker frequency of each of the at least two flexible light-emitting units connected to any one of the at least two node devices in any one of the light-emitting apparatuses.

11. A control method for the flexible splicable light-emitting apparatus according to claim 1, comprising:
obtaining a serial number of one node device of the at least two node devices and port connection status information of the one node device, and assigning and writing a first control address to the one node device according to the serial number of the one node device and the port connection status information of the one node device;
obtaining a serial number of an adjacent node device of the one node device and port connection status information of the adjacent node device of the one node device through the one node device, and assigning and writing a second control address to the adjacent node device according to the serial number of the adjacent node device and the port connection status information of the adjacent node device;
expanding step by step to acquire serial numbers of all of the at least two node devices and port connection status information of all of the at least two node devices in a light-emitting system, and assigning and writing a corresponding control address to each of the at least two node devices;
controlling a lighting of the plurality of light beads on the at least two flexible light-emitting units connected to each of the at least two node devices, performing a current detection operation on all of the plurality of light beads on each of the at least two flexible light-emitting units, and determining an effective length of each of the at least two flexible light-emitting units according to a number of light beads obtaining a current;
obtaining a topology satisfying the preset pattern according to the control addresses of all of the at least two node devices and the effective lengths of the at least two flexible light-emitting units connected to all ports of each of the at least two node devices; and
controlling the light-emitting effect of each of the at least two flexible light-emitting units through the at least two node devices to form a light-emitting area based on the topology, wherein
the effective length of each of the at least two flexible light-emitting units is a light-emitting length of each of the at least two flexible light-emitting units configured for being lit

12. The control method according to claim 11, further comprising:
acquiring a sound amplitude and/or a sound frequency within a preset range; and
controlling each of the at least two flexible light-emitting units in the flexible splicable light-emitting apparatus to correspondingly display a light-emitting brightness according to the sound amplitude, and controlling each of the at least two flexible light-emitting units in the flexible splicable light-emitting apparatus to correspondingly display a light-emitting color according to the sound frequency.

13. The flexible splicable light-emitting system according to claim 7, wherein the flexible splicable light-emitting apparatus, wherein each of the interfaces of the at least two node devices comprises an input terminal and a plurality of output terminals;
the plurality of output terminals of any one of the at least two node devices are connected to a first terminal of each of the at least two flexible light-emitting units in one-to-one correspondence; and
except for a first node device of the at least two node devices, the input terminal of any one of other node devices of the at least two node devices is connected to a second terminal of a previous flexible light-emitting unit of the at least two flexible light-emitting units.

14. The flexible splicable light-emitting system according to claim 7, wherein the flexible splicable light-emitting apparatus is further provided with an extender configured to extend a length of a light-emitting display line by connecting two of the at least two flexible light-emitting units;
if the preset pattern has a line with a linear distance greater than a preset length and displays a same color, the at least two flexible light-emitting units are connected using the extender to form a first light-emitting area of the line; and
if the preset pattern has the line with the linear distance greater than the preset length and does not display the same color, the at least two flexible light-emitting units are connected using the at least two node devices to form a second light-emitting area of the line.

15. The flexible splicable light-emitting system according to claim 14, wherein the flexible splicable light-emitting apparatus, wherein the two terminals of each of the at least two flexible light-emitting units are provided with an interface device configured to connect the at least two node devices and/or the extender; and the interface device is provided with 4-core signal lines, wherein the 4-core signal lines is a power line, a system data line, a lighting data line, and a ground line respectively.

16. The flexible splicable light-emitting system according to claim 7, wherein the flexible splicable light-emitting apparatus, wherein each of the at least two flexible light-emitting units is a flexible light strip, and the flexible light strip comprises the flexible base, a flexible circuit board, and the light-emitting component;
the flexible base has a length of 22-28 cm;
the flexible circuit board is disposed on the flexible base; and
the light-emitting component comprises a plurality of light beads uniformly distributed in a length direction of the flexible base, and each of the plurality of light beads is connected to the flexible circuit board.

17. The flexible splicable light-emitting system according to claim 7, wherein the flexible splicable light-emitting apparatus comprises at most 18 flexible light-emitting units.

18. The control method according to claim 11, wherein the flexible splicable light-emitting apparatus, wherein each of the interfaces of the at least two node devices comprises an input terminal and a plurality of output terminals;
the plurality of output terminals of any one of the at least two node devices are connected to a first terminal of each of the at least two flexible light-emitting units in one-to-one correspondence; and
except for a first node device of the at least two node devices, the input terminal of any one of other node devices of the at least two node devices is connected to a second terminal of a previous flexible light-emitting unit of the at least two flexible light-emitting units.

19. The control method according to claim 11, wherein the flexible splicable light-emitting apparatus is further provided with an extender configured to extend a length of a light-emitting display line by connecting two of the at least two flexible light-emitting units;
if the preset pattern has a line with a linear distance greater than a preset length and displays a same color, the at least two flexible light-emitting units are connected using the extender to form a first light-emitting area of the line; and
if the preset pattern has the line with the linear distance greater than the preset length and does not display the same color, the at least two flexible light-emitting units are connected using the at least two node devices to form a second light-emitting area of the line.

20. The control method according to claim 19, wherein the flexible splicable light-emitting apparatus, wherein the two terminals of each of the at least two flexible light-emitting units are provided with an interface device configured to connect the at least two node devices and/or the extender; and the interface device is provided with 4-core signal lines, wherein the 4-core signal lines is a power line, a system data line, a lighting data line, and a ground line respectively.
